(19) United States
(12) Patent Application Publication
(10) Pub. No.: US 2018/0181114 A1
(43) Pub. Date: Jun. 28, 2018

(54) LEARNING MODEL CONSTRUCTION DEVICE AND OVERHEAT PREDICTION DEVICE

(71) Applicant: FANUC CORPORATION, Minamitsuru-gun (JP)

(72) Inventor: Takashi MASAKAWA, Yamanashi (JP)

(21) Appl. No.: 15/852,635

(22) Filed: Dec. 22, 2017

(30) Foreign Application Priority Data
Dec. 26, 2016 (JP) 2016-251221

(51) Int. Cl. G05B 23/02; G06F 15/18

(52) U.S. Cl. CPC G05B 23/0289; G05B 23/0294; G05B 23/027; G06F 15/18

(57) ABSTRACT

A learning model construction device used in a machine tool which performs cutting processing constructs a learning model for learning temperature-related information after processing of a spindle motor during cutting processing. A learning model construction device includes an input unit that inputs cutting processing conditions and a present temperature of a spindle motor. The learning model construction device also includes a learning unit that receives the cutting processing conditions and the present temperature of the spindle motor and a label which is a temperature of the spindle motor after the cutting processing is performed as a set of teaching data and performs machine learning on the basis of the teaching data to thereby construct a learning model for learning temperature-related information. after processing of the spindle motor during the cutting processing.

This application is based on and claims the benefit of priority from Japanese Patent Application No. 2016-251221, filed on 26 Dec. 2016, the content of which is incorporated herein by reference.

### BACKGROUND OF THE INVENTION

### Field of the Invention

The present invention relates to a learning model construction device and an overheat prediction device used in a machine tool that performs cutting processing using a spindle to which an edged tool is attached and which is rotated by a spindle motor and a feed axis that moves the spindle in relation to a processing target.

### Related Art

Conventionally, in a numerically controlled machine tool, an acceleration speed or deceleration speed or a highest speed of a motor that drives a feed axis and a spindle provided in a machine tool is increased to shorten a processing time and to improve productivity. When such control is performed, a large current flows from a driving device of each shaft including a motor and an amplifier, and the number of accelerations/decelerations of the motor per unit time increases. As a result, the driving device generates heat. In the conventional technology, when the temperature of the driving device increases up to a predetermined temperature due to the generated heat, an alarm is issued to stop the machine tool. In this way, the driving device is prevented from being damaged by heat.

However, when the machine tool stops during processing, the processing efficiency decreases and a processing defect may occur. Particularly, when the machine tool is operated in an unattended state, an operator needs to recover the machine tool, and the machine tool may remain in a stopping state for a long period of time. In order to avoid such a problem, conventionally, an acceleration/deceleration value is set with a margin within a predetermined range of the largest number of accelerations/decelerations per unit time. In this way, the driving device is avoided from overheating.

However, since a temperature rise in the driving device is different depending on a weight or a material of a work, a processing load, an ambient temperature, and the like, the driving device may overheat even when the number of accelerations/decelerations is within the largest number of accelerations/decelerations. Moreover, even when a work is processed exceeding the largest number of accelerations/decelerations, the driving device may overheat similarly. Therefore, Patent Documents 1 and 2 disclose a device or a method capable of preventing overheating of a driving device so that the driving device can continue operating.

Patent Document 1 discloses that, when the temperature of a driving unit becomes a predetermined temperature or higher, acceleration is limited to suppress the output of the driving unit. However, in the invention disclosed in Patent Document 1, it is not possible to determine whether a processing condition after correction is appropriate unless the driving unit is operated. Thus, the driving unit may overheat even if the processing condition is lowered. Patent Document 2 discloses a method of controlling an acceleration or deceleration time constant so as to be an appropriate value at which overheat does not occur on the basis of the temperature of driving means and the number of accelerations/decelerations. However, in the invention disclosed in Patent Document 2, as described in paragraphs [0020] and the like, it is necessary to obtain a relation (a temperature curve) between a processing time and a motor temperature and a relation between an acceleration or deceleration time constant and an increase rate of temperature (an inclination of the temperature curve) in advance by experiments and store the obtained relations. Furthermore, the inclination of the temperature curve is not determined by the acceleration or deceleration time constant only but also depends on at least a load applied to the motor. Due to this, it is not possible to find out an acceleration time or a deceleration time constant appropriate for preventing overheat unless the load applied to processing is specified. The invention disclosed in Patent Document 2 relates to control of a feed axis but Patent Document 2 does not discuss control of a rotation speed of a spindle.

Patent Document 1: Japanese Unexamined Patent Application, Publication No. 2003-5836

Patent Document 2: Japanese Unexamined Patent Application, Publication No. H09-179623

### SUMMARY OF THE INVENTION

In cutting processing of a machine tool, which involves frequent acceleration or deceleration, the temperature of a spindle motor may increase due to several reasons and overheat is likely to occur. In general, whether overheat occurs or not depends on a frequency and a load of cutting processing and a spindle system (for example, a spindle motor, a spindle, a feed axis, or a tooling) used for the cutting processing. Therefore, it is difficult to find out a threshold appropriate for predicting overheat in advance.

In view of the above-described problem, an object of the present invention is to provide a learning model construction device capable of constructing a learning model for learning temperature-related information (temperature, a temperature rise, and the like) after processing a spindle motor during cutting processing from cutting processing conditions and a present temperature of the spindle motor. Another object of the present invention is to provide cutting processing conditions and an overheat prediction device capable of predicting whether a spindle motor overheats or not on the basis of the learning model.

(1) A learning model construction device (for example, a learning model construction device 20 to be described later) according to the present invention is a learning model construction device used in a machine tool (for example, a machine tool 15 to be described later) which performs cutting processing using a spindle to which an edged tool is attached and which is rotated by a spindle motor (for example, a spindle motor 16 to be described later) and a feed axis that feeds the spindle, the learning model construction device including: input means (for example, an input unit 21 to be described later) for inputting cutting processing conditions and a present temperature of the spindle motor; and learning means (for example, a learning unit 23 to be described later) for receiving the cutting processing conditions and the present temperature of the spindle motor and a label which is a temperature of the spindle motor after the cutting processing is performed as a set of teaching data and performing machine learning on the basis of the teaching data to thereby construct a learning model for learning temperature-related information after processing of the spindle motor during the cutting processing.

(2) In the learning model construction device according to (1), the temperature-related information may be a temperature or a temperature rise value.

(3) In the learning model construction device according to (1) or (2), the cutting processing conditions may include an acceleration or deceleration frequency of the spindle, a rotation speed, a cutting load, and a cutting time.

(4) An overheat prediction device (for example, an overheat prediction device 30 to be described later) according to the present invention includes: overheat prediction means (for example, an overheat prediction unit 31 to be described later) for predicting whether the spindle motor overheats or not from the cutting processing conditions and the present temperature of the spindle motor on the basis of the learning model constructed by the learning model construction device according to any one of (1) to (3).

(5) The overheat prediction device according to (4) may further include overheat prediction result output means (for example, an overheat prediction result output unit 32 to be described later) for outputting an overheat prediction result obtained by the overheat prediction means.

(6) The overheat prediction device according to (4) or (5) may further include processing condition correction means (for example, a processing condition correction unit 33 to be described later) for reexamining the cutting processing conditions when the overheat prediction means predicts that the spindle motor overheats and calculating correction conditions under which the spindle motor does not overheat.

(7) In the overheat prediction device according to (6), the processing condition correction means may calculate the correction conditions under which the spindle motor does not overheat by decreasing an acceleration or deceleration frequency of the spindle.

(8) In the overheat prediction device according to (6), the processing condition correction means may calculate the correction conditions under which the spindle motor does not overheat by decreasing a rotation speed of the spindle.

(9) The overheat prediction device according to any one of (6) to (8) may further include option presenting means (for example, an option presenting unit 34 to be described later) for presenting a plurality of correction conditions calculated by the processing condition correction means as options.

According to the present invention, it is possible to construct a learning model for learning temperature-related information (temperature, a temperature rise, and the like) after processing a spindle motor during cutting processing from the cutting processing conditions and the present temperature of the spindle motor. Moreover, it is possible to predict whether a spindle motor overheats or not on the basis of the learning model.

### BRIEF DESCRIPTION OF THE DRAWINGS

FIG. 1 is a block diagram illustrating an overheat prediction system according to a first embodiment of the present invention. FIG. 2 is a block diagram illustrating the details of a learning model construction device and an overheat prediction device according to the first embodiment of the present invention. FIG. 3 is a block diagram illustrating the details of a machine tool and a numerical controller according to the first embodiment of the present invention. FIG. 4 is a flowchart illustrating an operation during machine learning, of the overheat prediction system according to the first embodiment of the present invention. FIG. 5 is a flowchart illustrating an operation during overheat prediction, of the overheat prediction system according to the first embodiment of the present invention. FIG. 6 is a flowchart illustrating an operation during overheat prediction, of an overheat prediction system according to a second embodiment of the present invention.

### DETAILED DESCRIPTION OF THE INVENTION

### First Embodiment

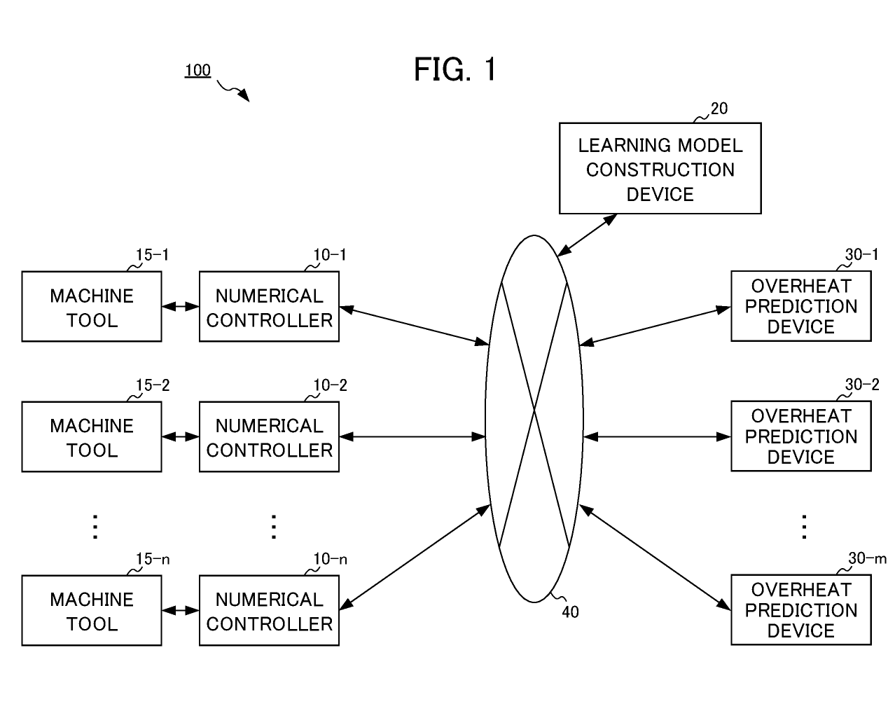

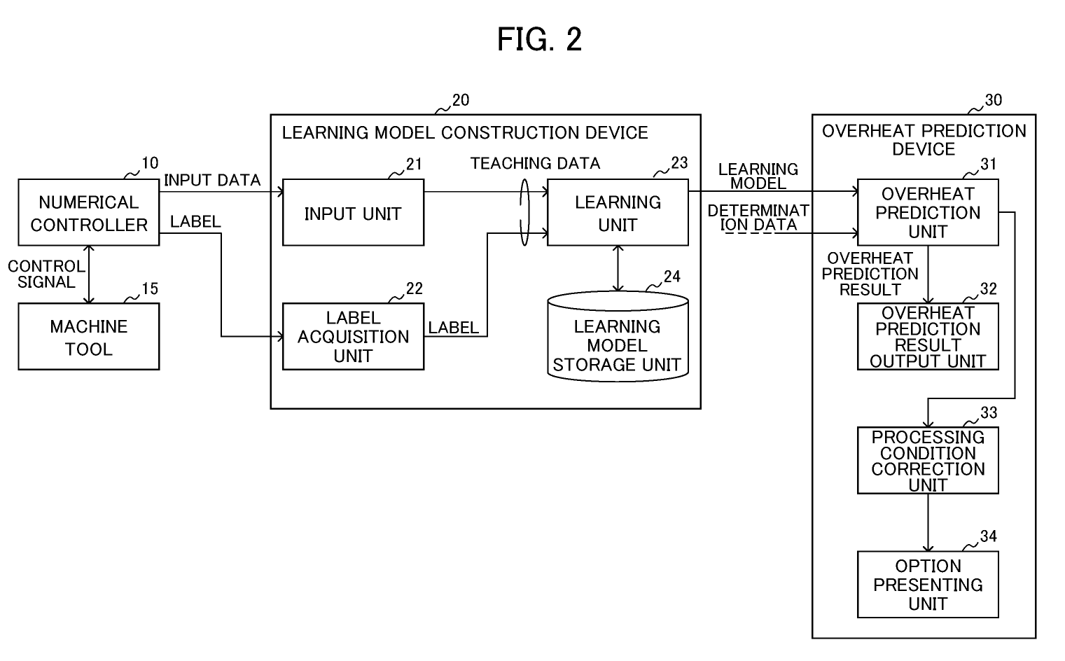

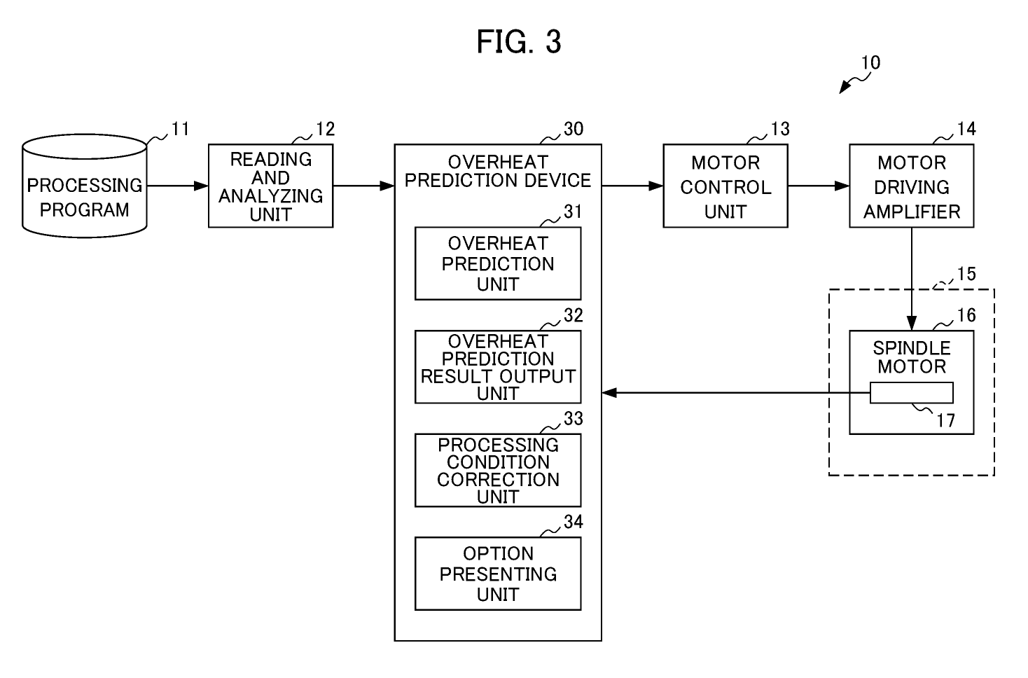

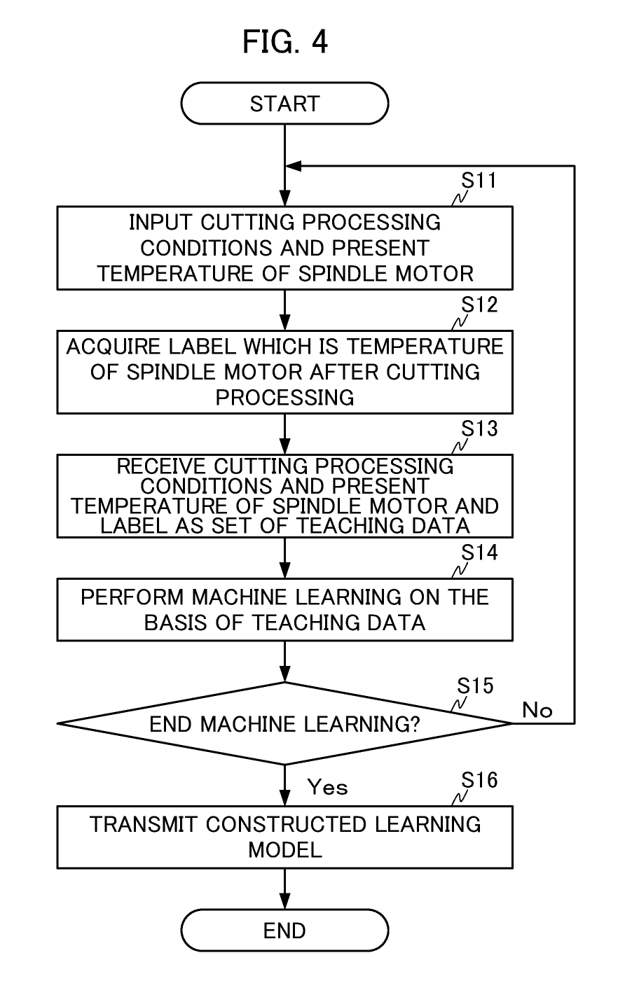

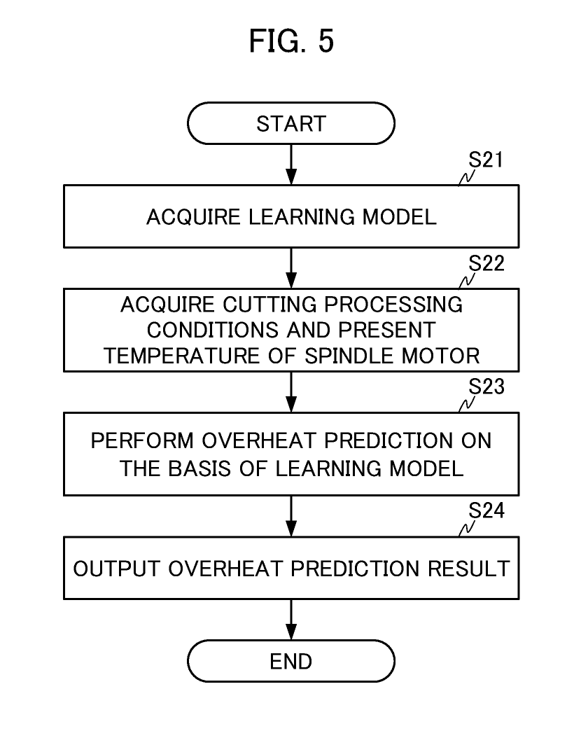

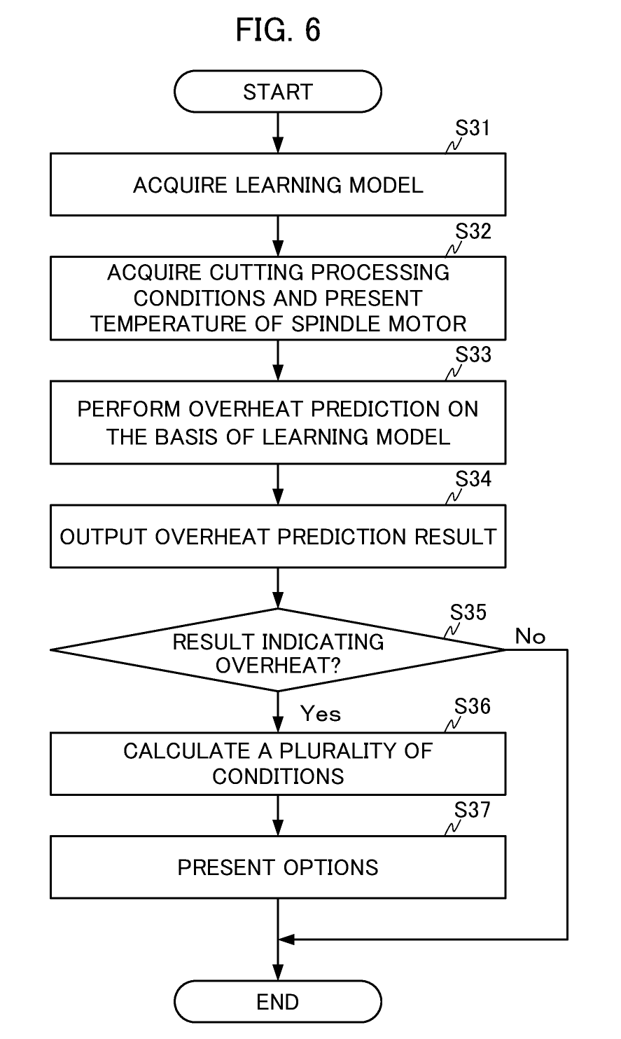

Hereinafter, a first embodiment of the present invention will be described with reference to the drawings. FIG. 1 is a block diagram illustrating an overheat prediction system according to the present embodiment. FIG. 2 is a block diagram illustrating the details of a learning model construction device and an overheat prediction device according to the present embodiment. FIG. 3 is a block diagram illustrating the details of a machine tool and a numerical controller according to the present embodiment.

### <Configuration of Overheat Prediction System>

First, a configuration of an overheat prediction system 100 according to the present embodiment will be described. As illustrated in FIG. 1, the overheat prediction system 100 includes n numerical controllers 10, n machine tools 15, a learning model construction device 20, m overheat prediction devices 30, and a network 40. n and m are arbitrary natural numbers.

Here, the numerical controller 10 and the machine tool 15 are paired in one-to-one correspondence and are connected communicably. A plurality of sets of numerical controller 10 and machine tool 15 may be provided in a same plant, for example, and may be provided in different plants.

Moreover, the machine tool 15, the learning model construction device 20, and the overheat prediction device 30 are connected to the network 40 and can perform communication mutually via the network 40. The network 40 is a local area network (LAN) constructed in a plant, the Internet, a public telephone network, or a combination thereof. A specific communication method of the network 40, whether wire connection or wireless connection is employed, and the like are not particularly limited.

Next, functions of these devices included in the overheat prediction system 100 will be described with reference to FIG. 2. Here, FIG. 2 is a block diagram illustrating functional blocks included in respective devices. Since the respective numerical controllers 10 have equivalent functions, only one numerical controller is illustrated in FIG. 2. Similarly, since the respective machine tools 15 and the respective overheat prediction devices 30 have equivalent functions, respectively, only one machine tool and only one overheat prediction device are illustrated in FIG. 2. Moreover, the networks 40 present between the respective devices are not illustrated.

As illustrated in FIG. 3, the machine tool 15 performs cutting processing using a spindle (not illustrated) to which an edged tool (not illustrated) is attached and which is rotated by a spindle motor 16 and a feed axis (not illustrated) that feeds the spindle. That is, this edged tool is rotated by the spindle motor 16 that drives the spindle and is fed by a feed axis motor (not illustrated) that drives the feed axis. In cutting processing, it is assumed that since an operation of the feed axis is synchronized with an operation of the spindle, the feed axis is controlled automatically by controlling the spindle motor 16.

Moreover, a temperature detection unit 17 that detects the temperature of the spindle motor 16 is provided in the spindle motor 16. The temperature detection unit 17 may be included in the spindle motor 16 and may be provided near the spindle motor 16. Alternatively, the temperature detection unit 17 may estimate the temperature of the spindle motor 16 from a current flowing in the spindle motor 16 instead of directly detecting the temperature of the spindle motor 16.

As illustrated in FIGS. 2 and 3, the numerical controller 10 outputs a control signal to the machine tool 15 to control the machine tool 15 so as to perform predetermined cutting processing. A plurality of processing programs 11 determined according to a processing content of a work (not illustrated) is stored in the numerical controller 10, The numerical controller 10 includes a reading and analyzing unit 12 that reads and analyzes the processing program 11, extracts cutting processing conditions (an acceleration or deceleration frequency of a spindle, a rotation speed, a cutting load, and a cutting time), and outputs the extracted cutting processing conditions to the overheat prediction device 30, a motor control unit 13 that creates an operation command for driving the spindle motor 16 of the machine tool 15 on the basis of position command data, and a motor driving amplifier 14 that amplifies the operation command and outputs the operation command to the spindle motor 16 of the machine tool 15.

As illustrated in FIG. 2, the learning model construction device 20 constructs a learning model for learning the temperature as the temperature-related information after processing of the spindle motor 16 during cutting processing by supervised machine learning. For this, the learning model construction device 20 includes an input unit 21, a label acquisition unit 22, a learning unit 23, and a learning model storage unit 24.

The input unit 21 inputs the cutting processing conditions and the present temperature of the spindle motor 16. Here, the present temperature of the spindle motor 16 is an output value of the temperature detection unit 17 and the cutting processing condition is an output value of the reading and analyzing unit 12. The label acquisition unit 22 acquires a label which is the temperature of the spindle motor after cutting processing. The learning unit 23 receives the cutting processing conditions and the present temperature of the spindle motor 16 and the label as a set of teaching data and performs machine learning on the basis of the teaching data to thereby construct a learning model for learning the temperature after processing of the spindle motor 16 during cutting processing. The learning model storage unit 24 stores the learning model constructed by the learning unit 23. The learning unit 23 may perform machine learning according to a learning model constructed by a neural network including a multi-layer neural network.

As illustrated in FIG. 2, the overheat prediction device 30 predicts whether the spindle motor 16 overheats or not. For this, the overheat prediction device 30 includes an overheat prediction unit 31, an overheat prediction result output unit 32, a processing condition correction unit 33, and an option presenting unit 34. As illustrated in FIG. 3, the overheat prediction device 30 receives the output value of the reading and analyzing unit 12 of the numerical controller 10 and the output value of the temperature detection unit 17 of the machine tool 15 as an input and outputs the cutting processing conditions to the motor control unit 13 of the numerical controller 10.

The overheat prediction unit 31 predicts whether the spindle motor 16 overheats or not from the cutting processing conditions and the present temperature of the spindle motor 16 on the basis of the learning model constructed by the learning model construction device 20. The overheat prediction result output unit 32 outputs the prediction result obtained by the overheat prediction unit 31.

The processing condition correction unit 33 reexamines the cutting processing conditions and calculates a plurality of correction conditions under which the spindle motor 16 does not overheat when the overheat prediction unit 31 predicts that the spindle motor 16 will overheat. A specific calculation method will be described later.

The option presenting unit 34 presents the plurality of correction conditions calculated by the processing condition correction unit 33 as options.

### <Operation During Machine Learning>

Next, an operation during machine learning of the overheat prediction system 100 according to the present embodiment will be described. FIG. 4 is a flowchart illustrating an operation of the learning model construction device 20 during machine learning.

First, in step S11, the input unit 21 of the learning model construction device 20 acquires the cutting processing conditions and the present temperature of the spindle motor 16 from any one of the numerical controllers 10 as input data.

Subsequently, in step S12, the label acquisition unit 22 of the learning model construction device 20 acquires a label which is the temperature of the spindle motor after cutting processing.

After that, in step S13, the learning unit 23 of the learning model construction device 20 receives the cutting processing conditions and the present temperature of the spindle motor 16 and a label as a set of teaching data. Subsequently, in step S14, the learning unit 23 of the learning model construction device 20 executes machine learning using the teaching data.

In step S15, the learning unit 23 of the learning model construction device 20 determines whether machine learning is to be ended or machine learning is to be repeated. Here, whether the machine learning is to be ended can be determined arbitrarily. For example, the machine learning may be ended when machine learning is repeated for a predetermined number of times.

Here, when the machine learning is repeated, the learning model construction device 20 returns to step S11 and repeats the same operations. On the other hand, when the machine learning is ended, the learning model construction device 20 transmits the learning model constructed by the machine learning by that time point to the respective overheat prediction devices 30 via the network 40 in step S16.

Moreover, the learning model storage unit 24 of the learning model construction device 20 stores the learning model. In this way, when a learning model is requested from a newly installed overheat prediction device 30, it is possible to transmit the learning model to the overheat prediction device 30. Moreover, when new teaching data is acquired, machine learning can be performed further according to the learning model.

### <Operation During Overheat Prediction>

Next, the operation during overheat prediction of the overheat prediction system 100 according to the present embodiment will be described. FIG. 5 is a flowchart illustrating the operation of the overheat prediction device 30 during overheat prediction.

First, in step S21, the overheat prediction unit 31 of the overheat prediction device 30 acquires a learning model by receiving the learning model constructed by the learning model construction device 20 via the network 40. In step S22, the overheat prediction unit 31 of the overheat prediction device 30 acquires the cutting processing conditions and the present temperature of the spindle motor 16 as determination data.

In step S23, the overheat prediction unit 31 of the overheat prediction device 30 predicts whether the spindle motor 16 overheats or not from the cutting processing conditions and the present temperature of the spindle motor 16 on the basis of the learning model constructed by the learning model construction device 20.

In step S24, the overheat prediction unit 31 of the overheat prediction device 30 outputs the overheat prediction result (roughly, a result indicating that overheat occurs or a result indicating that overheat does not occur) to the overheat prediction result output unit 32. Upon receiving the overheat prediction result, the overheat prediction result output unit 32 outputs the overheat prediction result. As an output method, a method of displaying the overheat prediction result on a screen (not illustrated) , for example, may be considered.

In this way, in the present embodiment, the learning model construction device 20 can construct a learning model for learning the temperature after processing of the spindle motor 16 during cutting processing from the cutting processing conditions and the present temperature of the spindle motor.

Moreover, the overheat prediction device 30 can predict whether the spindle motor 16 overheats or not on the basis of the learning model constructed by the learning model construction device 20.

In this respect, the conventional method (the method disclosed in Patent Document 1) limits acceleration to suppress the output of the driving unit when the temperature of the driving unit becomes equal to or higher than a predetermined temperature. However, it is not possible to determine whether a processing condition after correction is appropriate unless the driving unit is operated. Thus, the driving unit may overheat even if the processing condition is lowered. In contrast, the present invention can put the processing conditions into machine learning to examine whether overheat occurs or not. Moreover, in the conventional method (the method disclosed in Patent Document 2), it is necessary to obtain a relation between an acceleration or deceleration time constant and an increase rate of temperature (an inclination of the temperature curve) in advance by experiments and store the obtained relation. Furthermore, the inclination of the temperature curve is not determined by the acceleration or deceleration time constant only but also depends on at least a load applied to the motor. Due to this, it is not possible to find out an acceleration or deceleration time constant appropriate for preventing overheat unless the load applied to processing is specified. In contrast, in the present invention, since how the spindle temperature will change when certain processing is performed is learned, it is possible to find out an appropriate processing condition under which overheat does not occur without performing experiments in advance. As described above, in the present invention, it is possible to predict overheat appropriately in cutting processing in which whether overheat occurs or not depends on a spindle system used, a processing frequency, and a processing load,

Since the plurality of numerical controllers 10 is connected to the learning model construction device 20 via the network 40 as illustrated in FIG. 1, a learning model constructed by an arbitrary machine tool 15 can be used by other arbitrary machine tools 15. In this case, even when the tool (edged tool) used for cutting processing is different in respective machine tools 15, since a difference in tooling appears as a difference in the cutting load of the spindle, unless the specifications of other elements (the spindle motor 16, the spindle, the feed axis, and the like) of the spindle system. are different, the learning model can be shared by the plurality of machine tools 15.

### Second Embodiment

Hereinafter, a second embodiment of the present invention will be described with reference to the drawings. FIG. 6 is a flowchart illustrating an operation during overheat prediction of an overheat prediction system according to the present embodiment.

In the first embodiment, the operation during overheat prediction of the overheat prediction device 30 has been described for a case in which processing ends at a time point at which an overheat prediction result is output after the overheat prediction unit 31 predicts whether the spindle motor 16 overheats or not.

In contrast, in the second embodiment, after the overheat prediction result is output, when it is predicted that overheat may occur, the cutting processing conditions are reexamined to calculate a plurality of correction conditions under which the spindle motor 16 does not overheat. Furthermore, the plurality of correction conditions is presented as options. The configuration of the overheat prediction system 100 is the same as that of the first embodiment.

The operation during overheat prediction according to the present embodiment will be described. First, in step S31, the overheat prediction unit 31 of the overheat prediction device 30 acquires a learning model by receiving the learning model constructed by the learning model construction device 20 via the network 40. In step S32, the overheat prediction unit 31 of the overheat prediction device 30 acquires the cutting processing conditions and the present temperature of the spindle motor 16.

In step S33, the overheat prediction unit 31 of the overheat prediction device 30 predicts whether the spindle motor 16 overheats or not from the cutting processing conditions and the present temperature of the spindle motor 16 on the basis of the learning model constructed by the learning model construction device 20.

In step S34, the overheat prediction unit 31 of the overheat prediction device 30 outputs the overheat prediction result to the overheat prediction result output unit 32. Upon receiving the overheat prediction result, the overheat prediction result output unit 32 outputs the overheat prediction result (roughly, a result indicating that overheat occurs or a result indicating that overheat does not occur). As an output method, a method of displaying the overheat prediction result on a screen (not illustrated), for example, may be considered.

Subsequently, in step S35, the overheat prediction device 30 determines whether the overheat prediction result indicates that overheat occurs. When the overheat prediction result indicates that overheat does not occur, the process ends. On the other hand, when the overheat prediction result indicates that overheat occurs, the processing condition correction unit 33 of the overheat prediction device 30 reexamines the cutting processing conditions to calculate several (for example, five) correction conditions under which the spindle motor 16 does not overheat.

Specifically, several conditions among the cutting processing condition (an acceleration or deceleration frequency of a spindle, a rotation speed, a cutting load, and a cutting time) are changed in an incremental manner, for example, to thereby calculate correction conditions under which the spindle motor 16 does not overheat. For example, the frequency of acceleration or deceleration of the spindle may be decreased and the rotation speed of the moving speed may be decreased. In this case, since the processing time increases if the rotation speed of the spindle is decreased, the other cutting processing conditions may be increased so as to cancel these changes.

In step S37, the option presenting unit 34 of the overheat prediction device 30 presents the plurality of correction conditions calculated in this manner to an operator as options. As a presentation method, a method of displaying a plurality of correction conditions on a screen (not illustrated), for example, may be considered. When the operator selects a correction condition by referring to the presented content, the selected correction condition is output from the overheat prediction device 30 to the motor control unit 13 of the numerical controller 10, and the machine tool 15 executes cutting processing according to the correction condition.

In this case, since the correction condition presented to the operator is calculated by changing the cutting processing conditions in an incremental manner, the correction condition is close to the present processing condition. Therefore, it is possible to execute cutting processing while increasing productivity as much as possible within a range where the spindle motor 16 does not overheat.

Therefore, the present embodiment provides the following advantages in addition to the advantages of the first embodiment.

That is, even when the overheat prediction device 30 predicts that the spindle motor 16 overheats, it is possible to perform cutting processing continuously while avoiding occurrence of overheat. Therefore, it is possible to avoid problems such as a decrease in processing efficiency due to stopping of the machine tool 15 and the occurrence of processing defects.

### Other Embodiments

Although the respective embodiments are preferred embodiments of the present invention, the scope of the present invention is not to be limited to the afore-mentioned respective embodiments, and the present invention can be modified in various ways without departing from the gist of the present invention.

In the first and second embodiments described above, a case in which the learning model construction device 20 constructs a learning model for learning the temperature as temperature-related information after processing of the spindle motor 16 during cutting processing has been described. However, the temperature-related information is not limited to the temperature but may be a temperature rise value.

Moreover, in the first and second embodiments described above, a case in which an acceleration or deceleration frequency of a spindle, a rotation speed, a cutting load, and a cutting time are employed as the cutting processing conditions has been described. However, an outside temperature (an ambient temperature of the spindle), for example, may be added to the cutting processing conditions.

Moreover, in the first and second embodiments described above, a case in which the machine tool 15 performs the cutting processing has been described. However, the present invention can be similarly applied to a case in which the machine tool 15 performs a series of processing by adding another processing (for example, punching processing) to the cutting processing.

Moreover, in the first and second embodiments described above, a case in which the reading and analyzing unit 12 of the numerical controller 10 reads and analyzes the processing program 11 to extract cutting processing conditions and outputs the cutting processing condition to the overheat prediction device 30 has been described. However, the cutting processing conditions may be manually input by an operator. For example, since the cutting load of the spindle is different depending on the type (material) of a work, unless the type of the work is described in the processing program 11, it is not possible to extract the cutting load of the spindle from the program 11. Therefore, it is preferable that the cutting processing conditions are manually input by an operator. Moreover, although the cutting load of the spindle increases if the sharpness of a tooling (an edged tool) used for cutting processing becomes worse, since the sharpness cannot be extracted from the program 11, it is also preferable that the cutting processing conditions are manually input by an operator.

In the second embodiment, a case in which when it is predicted that the spindle motor 16 overheats, cutting processing is performed under new conditions under which overheat does not occur has been described. However, when overheat of the spindle motor 16 is predicted, an operator may be warned of the overheat. Alternatively, next processing may be stopped temporarily and it may be waited until a spindle system (the spindle motor 16, the spindle, the feed axis, the tooling, and the like) cools down.

### EXPLANATION OF REFERENCE NUMERALS

15: Machine tool
16: spindle motor
20: Learning model construction device
21: input unit (Input means)
23: Learning unit (Learning means)
30: Overheat prediction device
31: Overheat prediction unit (Overheat prediction means)
32: Overheat prediction result output unit (Overheat prediction result output means)
33: Processing condition correction unit (Processing condition correction means)
34: Option presenting unit (Option presenting means)

What is claimed is:

1. A learning model construction device used in a machine tool which performs cutting processing using a spindle to which an edged tool is attached and which is rotated by a spindle motor and a feed axis that feeds the spindle, the learning model construction device comprising:
input means for inputting cutting processing conditions and a present temperature of the spindle motor; and
learning means for receiving the cutting processing conditions and the present temperature of the spindle motor and a label which is a temperature of the spindle motor after the cutting processing is performed as a set of teaching data and performing machine learning on the basis of the teaching data to thereby construct a learning model for learning temperature-related information after processing of the spindle motor during the cutting processing.

2. The learning model construction device according to claim 1, wherein
the temperature-related information is a temperature or a temperature rise value.

3. The learning model construction device according to claim 1, wherein
the cutting processing conditions include an acceleration or deceleration frequency of the spindle, a rotation speed, a cutting load, and a cutting time.

4. An overheat prediction. device comprising:
overheat prediction means for predicting whether the spindle motor overheats or not from the cutting processing conditions and the present temperature of the spindle motor on the basis of the learning model constructed by the learning model construction device according to claim 1.

5. The overheat prediction device according to claim 4, further comprising:
overheat prediction result output means for outputting an overheat prediction result obtained by the overheat prediction means.

6. The overheat prediction device according to claim 4, further comprising:
processing condition correction means for reexamining the cutting processing conditions when the overheat prediction means predicts that the spindle motor overheats and calculating correction conditions under which the spindle motor does not overheat.

7. The overheat prediction device according to claim 6, wherein
the processing condition correction means calculates the correction conditions under which the spindle motor does not overheat by decreasing an acceleration or deceleration frequency of the spindle.

8. The overheat prediction device according to claim 6, wherein
the processing condition correction means calculates the correction conditions under which the spindle motor does not overheat by decreasing a rotation speed of the spindle.

9. The overheat prediction device according to claim 6, further comprising:
option presenting means for presenting a plurality of correction conditions calculated by the processing condition correction means as options.
